(19) United States
(12) Patent Application Publication
(10) Pub. No.: US 2023/0245248 A1
(43) Pub. Date: Aug. 3, 2023

(54) Open-Source Dating Platform

(71) Applicants: Melody Adeniyi, Chicago, IL (US); Adebola Adeniyi, Chicago, IL (US); Moses Adeniyi, Chicago, IL (US); Noah Adeniyi, Chicago, IL (US)

(72) Inventors: Melody Adeniyi, Chicago, IL (US); Adebola Adeniyi, Chicago, IL (US); Moses Adeniyi, Chicago, IL (US); Noah Adeniyi, Chicago, IL (US)

(21) Appl. No.: 17/377,891

(22) Filed: Feb. 1, 2022

(51) Int. Cl. G06Q 50/00

(52) U.S. Cl. CPC G06Q 50/01

(57) ABSTRACT

The present invention generally relates to an open-source dating platform which facilitates the submission and retrieval of reviews and ratings of individuals within a dating or romantic relationship context. A system consistent with the present invention may receive a first query from a first user on an open-source dating platform seeking to submit a review of a first dating prospect's behavior within a romantic relationship. The system further prompts the first user to submit identifying information of the first dating prospect. The system can confirm the romantic relationship between the first user and the first dating prospect using social media data. In addition, the system can receive the review from the first user regarding its romantic relationship with the first dating prospect.

### FIELD OF DISCLOSURE

The present invention generally relates to an open-source dating platform which facilitates the submission and retrieval of reviews and ratings of individuals within a dating or romantic relationship context.

### BACKGROUND

Many times, when an individual meets a potential suitor, they want to get to know whether there is a potential for a romantic relationship and whether the relationship can go the distance. However, some people simply desire the highs of the dating game, without any intention of pursuing a serious relationship. Therefore, when the signals of commitment arise, they run, leaving their former partners clueless, stranded, and alone with no choice but to pick up the pieces they left behind and move forward. Those who seek a serious long-term relationship often struggle with meeting suitors with the same objective.

Therefore, a need exists for a system that facilitates the submission and retrieval of reviews and ratings of former partners and lovers and a dating prospect's fitness to function within a romantic relationship. The present invention meets this need.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

The present invention provides an open-source dating platform which allows users to submit and retrieve reviews of dating prospects. A system consistent with the present invention receives a first query from a first user on an open-source dating platform seeking to submit reviews of a first dating prospect's behavior within a romantic relationship. The system prompts the first user to submit identifying information of the first dating prospect. The system confirms the romantic relationship between the first user and the first dating prospect using social media data. The system receives the review from the first user regarding its romantic relationship with the first dating prospect.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present invention. This text is included for illustrative, non-limiting, explanatory purposes of certain embodiments detailed in the present invention. In the drawings:

FIG. 1 illustrates an example computer network system which can facilitate an open-source dating platform according to one or more examples of the present invention;

FIGS. 2A-2E illustrate an exemplary process for generating a dating timeline in accordance with one embodiment consistent with the present invention;

FIG. 3 illustrates a cluster of dating timelines in accordance with one embodiment consistent with the present invention;

FIGS. 4A-4D illustrate an exemplary process for generating a dating tree in accordance with one embodiment consistent with the present invention;

FIG. 5 illustrates example sociograms in accordance with one embodiment consistent with the present invention;

FIGS. 6A-6D illustrate an exemplary process for generating relationship images according to one or more embodiments of the present invention; and

FIGS. 7-10 illustrate computing systems according to one or more embodiments of the present invention.

### DETAILED DESCRIPTION

As a preliminary matter, it will readily be understood by one having ordinary skill in the relevant art that the present invention has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present invention. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present invention.

Accordingly, while embodiments are described herein in detail in relation to one or more embodiments, it is to be understood that this disclosure is illustrative and exemplary of the present invention and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present invention contains headers. It should be understood that these headers are used as references and are not to be construed as limiting upon the subjected matter disclosed under the header.

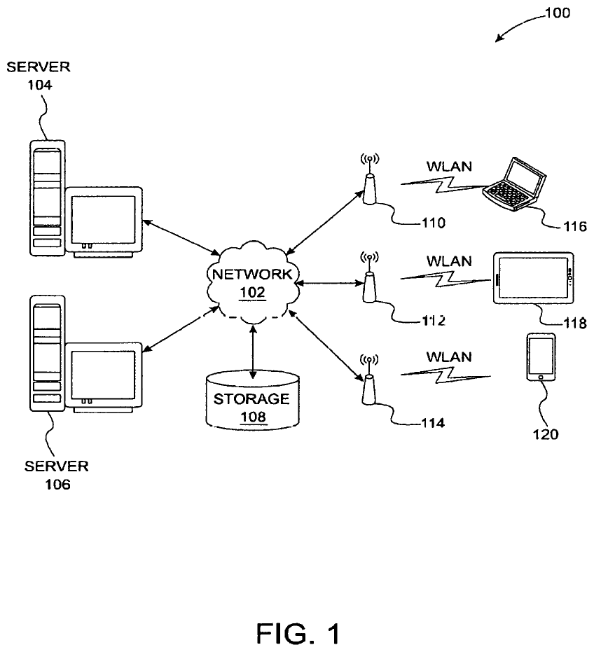

FIG. 1 illustrates an example computer network system 100 which can facilitate an open-source dating platform according to one or more examples of the present invention. In one or more embodiments of the present invention, the open-source dating platform is implemented by a software application. The open-source dating platform may be hosted on one or more servers 104, 106 with system data stored thereon or in peripheral databases 108.

Herein, an open-source dating platform is defined as a dating platform which accumulates and aggregates information and data submitted by its users pertaining to dating and romantic relationships. Accordingly, the information pertaining to one's dating history or behavior within a relationship is not limited to the sentiment and account of the person of interest as the information submitted to the open-source dating platform may originate from third parties (e.g., former partners, lovers, or witnesses of the relationship). It should be understood by one having ordinary skill in the art that a person of interest is any individual for whom a dating profile which contains digital dating artifacts is created. Herein, a digital dating artifact is a digital object which expresses one or more attributes of a person of interest or past or present relationship.

In some embodiments, a dating profile may include a dating timeline, dating tree, sociogram, relationship image, or other digital dating artifact which reflects a person of interest's dating performance and dating history.

In one embodiment, a dating platform is created by or contributed to by an individual other than the person of interest whereas a user's profile on the open-source dating platform is created by and contributed to by that user. As such, a user on the open-source dating platform may have both a user profile, which he or she has created as a member on the platform, and a dating profile which may be created by third parties.

It should be understood by one having ordinary skill in the art that although a person of interest may not be a user on the open-source dating platform, a dating profile may be created for the person of interest based on the ratings and reviews submitted by others. Without violating a person of interest's right to privacy, third parties can submit accurate information about the person of interest based on the third parties' experience with the person of interest within a dating context. Because one cannot engage in a romantic relationship with oneself, but with others, individuals inherently give up some rights to privacy as all individuals have a right to speak their truth about their past or present relationships so long as doing so does not run afoul of the law.

Furthermore, the identity of the submitter of reviews, ratings, etc. to the open-source dating platform may be disclosed on each the open-source dating platform. For example, the identify of each contributor may be linked, listed, etc. to each digital dating artifact. Therefore, users on the platform, and the individual persons of interest whom the digital dating artifacts are assigned, are made aware of each contributor to the person of interest's dating profile.

In some embodiments, only third parties can contribute to a person of interest's (e.g., dating prospect) dating profile. As such, in one embodiment of the present invention, the dating trees, dating timelines, and other digital dating artifacts on the open-source dating platform are constructed from the input of third parties rather than by the person of interest themselves. Therefore, any attempt to sanitize one's dating history or past dating behavior can be deterred as an objective of the present invention is to provide a platform for users to gain accurate and comprehensive information regarding a dating prospect's dating performance and history.

The open-source dating platform described herein may facilitate the submission of ratings and reviews without requiring a formal membership so long as users can verify the identity of themselves and those of whom they intend to submit the ratings or reviews. As such, the open-source dating platform may be configured to encourage users to populate the dating platform with detailed information of their dating experiences for the benefit of all of its users while maintaining the integrity of the system.

In addition, the open-source dating platform may feature an interface which allows users to submit or retrieve information therefrom. The interface may be displayed on a graphical user interface of a client device. Information presented by or on the interface may enable users to submit and retrieve information to the open-source dating platform. The interface can allow users to perform queries to access user and dating profiles, etc. and can prompt users to submit information regarding a person of interest's dating behavior and dating history.

In one or more embodiments of the present invention, an application programming interface (API) may facilitate a connection with one or more social media platforms (e.g., Facebook). The open-source dating platform can retrieve data pertaining to relationship data (e.g., relationship status). Accordingly, a user can create a log (e.g., digital dating log) of its dating history on the open-source dating platform by giving the dating platform access to its social media accounts such that information relevant to the user's dating life can be retrieved and added to the user's dating profile on the open-source dating platform.

Computer network system 100 is a network of data processing systems, such as, for example, computers and other devices, in which the illustrative embodiments may be implemented. One or more client devices employed within computer network system 100 may include a display screen, a plurality of microprocessors, and memory.

Computer network system 100 may include one or more networks which provide communication links between the various computers and other devices connected together within the computer network system 100. In some implementations, network 102 may include connections, such as wire(s), wireless communication links, fiber optic cables, etcetera.

In the example depicted in computer network system 100, a server 104, server 106, and storage unit 108 are all connected to network 102. Storage unit 108 may be capable of storing data in a structured or unstructured format. Additionally, storage unit 108 may represent a plurality of storage units coupled to network 102. In some implementations of the present invention, storage unit 108 may, for example, include any database within an enterprise that stores and manages reusable software assets and any other data related to these reusable software assets. Access Points 110, 112, and 114 may function as a network device that allows client device to connect to a wired network. However, the present invention is not limited thereto. In some implementations, an access point may connect to a router as a standalone device but may also be an integral component of the router itself in some implementations.

In addition, the access points 110, 112, 114 may provide wireless access to client devices 116, 118, 120. The client devices may include personal computers, network computers, laptop computers, hand-held computers, personal digital assistants (PDAs), or smart cellular telephones (e.g., smartphones). In the embodiment shown, client device 116 is a laptop computer, client device 118 is a tablet, and client device 120 is a smartphone device. However, one having ordinary skill in the art should appreciate that the present invention is not limited to the client devices shown in FIG. 1. It should also be understood by those having ordinary skill in the art that the client devices can be used to access and submit information to the open-source dating platform.

In the implementation shown, access points 110, 112, and 114 are clients to server 104 and/or server 106. In addition, server 104 and/or server 106 may provide data, such as, for example, boot files, operating system images, and applications to access points 110, 112, and 114. Computer network system 100 may include additional servers, clients, and other devices not shown to implement processes of illustrative implementations.

Computer network system 100 may be implemented as a number of different types of networks, such as, for example, an intranet, a local area network (LAN), a wide area network (WAN), or the Internet. It should be noted that FIG. 1 is only intended as an example and not as an architectural limitation for the different illustrative implementations. For example, illustrative implementations may be implemented within a single data processing system or within a computer network system.

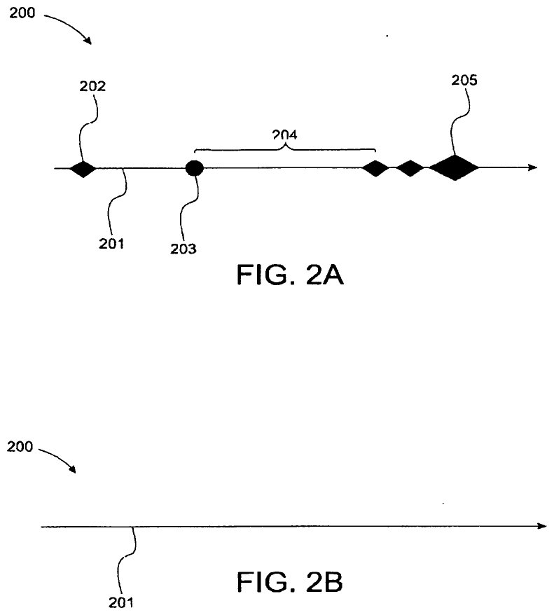

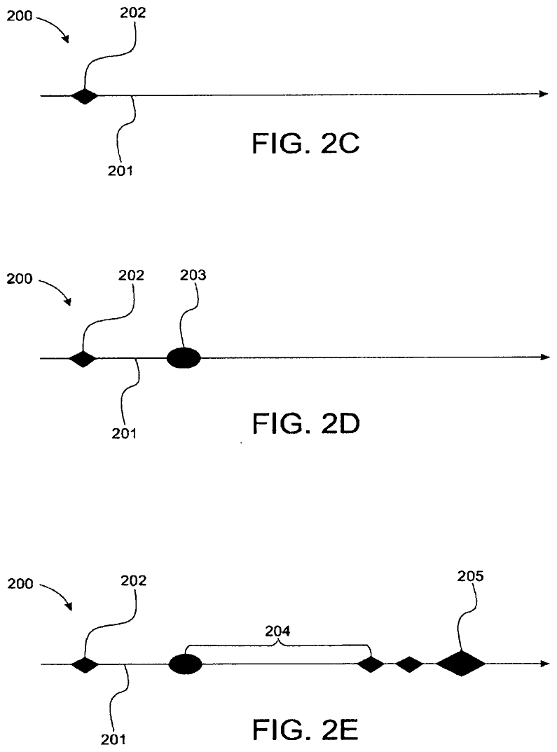

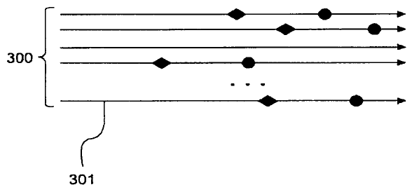

FIGS. 2A-2E illustrate an exemplary process for generating a dating timeline 200 in accordance with one embodiment consistent with the present invention. In one embodiment, dating timeline 200 features a timeline axis 201 upon which markers (e.g., markers 202, 203, and 206) can be added thereto. The markers may be indicative of any of various types of romantic relationships or courtships such as, but not limited to, a monogamous relationship, a polyamorous relationship, an open relationship, a casual sexual relationship, etcetera.

Notably, dating timeline 200 provides a visual representation of one's dating history. Dating timeline 200, which is assigned to a person of interest, can be compared with the dating timelines assigned to other individuals which may or may not be a user on the open-source dating platform. In addition, dating timeline 200 may be characterized according to its attributes such that a label can be assigned to the individual for which the dating timeline 200 was created.

For instance, an exemplary dating timeline may depict a marker which indicates the engagement of a monogamous relationship that lasted for over four years closely followed by a series of markers which indicate short (e.g., five months), non-monogamous sexual relationships. This segment of a dating timeline, for this example, may indicate that the user has engaged in rebound “relations” to ease the pain from a loss of a romantic relationship.

The markers on dating timeline 200 can vary in size and shape. The markers on the dating timeline 200 may have other attributes such as, but not limited to, color, hashing, special effects, etc. For example, a color attribute of a marker may indicate that the individual of whom the dating timeline 200 was assigned has a pattern of engaging in short-term casual relationships (e.g., “flings”).

Moreover, attributes of the markers may communicate the type, duration, rating, review, and confirmation that a romantic relationship existed. For example, marker 202 has a diamond shape which may indicate a first type of relationship (e.g., monogamous relationship) whereas marker 203 has a circular shape which is indicative of a second type of relationship (e.g., non-monogamous relationship). Notably, marker 206 is significantly larger in size than marker 202. The size of the marker may be indicative of the duration in time that the relationship existed. As such, the relationship represented by marker 206 lasted longer in time than the relationship represented by marker 202. However, in yet other embodiments, the size of the marker is indicative of the number of persons which have confirmed the existence of the romantic relationship represented by the marker. As such, users on the open-source dating platform can have confidence in the dating timelines which have markers that reflect the confirmation that the romantic relationship represented by the marker.

The markers on the timeline axis 201 may display information when selected by a user on the open-source dating platform. For example, when a user selects a marker, information regarding the parties involved in the romantic relationship, the duration of the relationship, the rating and/or review of the persons involved in the relationship, etc. may be displayed.

The timeline axis 201 may include any of various attributes to provide additional information about the person of interest's dating history and performance. For example, timeline axis 201 may have a color attribute which may be indicative of a user's fitness to function within a romantic relationship. In yet other embodiments, a color attribute may be indicative of the type of relationship that the user has mostly engaged in (e.g., monogamous relationship). The color attribute may be an example of the sentiments submitted by users on the platform.

A user's dating timeline can be the basis, or a factor, for generating targeted advertisements. For example, if a dating timeline indicates that a user is presently single, targeted advertisements for singles (e.g., advertisements for “Singles' Day”) can be generated and directed to single users on the open-source dating platform. For instance, studies have shown that singles spend higher proportions of their incomes on clothes, food, restaurants, leisure, and entertainment. Singles have also been found more tolerant of risk, less price-conscious, more brand-focused, and drawn to convenience when it comes to consumption and buying. Accordingly, digital dating artifacts, such as dating timelines, may be accessible to merchants with access to data on the open-source dating platform to discriminate users for targeting purposes.

Likewise, if a user's dating timeline indicates that the user is presently in a romantic relationship, such as a monogamous relationship, advertisements which are targeted to consumers in romantic relationships can be generated and directed to these users. For example, advertisements may be directed to users that are currently in a romantic relationship for special holidays such as Valentine's Day.

Data within the open-source dating platform may be sold to third party merchants as one manner of monetization. One having ordinary skill in the art may appreciate that an API or other suitable mechanism may be used to deliver advertisements to users on the open-source dating platform or other social media platform for which the user has an account.

Furthermore, an open-source dating platform can aggregate data pertaining to one's dating performance and attributes of romantic relationships. As such, the open-source dating platform creates records of romantic relationships which can be accessed by the public. The accumulation and aggregation of relationship data can allow for a greater understanding of human behavior, social interactions, and mating norms.

The dating timeline 200 may be characterized such that its distinctive attributes can be correlated with other dating timelines on the open-source dating platform. In addition, a dating timeline 200 may be compared to pre-defined dating timeline profiles to be characterized. Each of the data timeline profiles may have features that are attributable to a set of traits, behaviors, and characteristics which are relevant to an individual's fitness to function properly within a romantic relationship.

FIGS. 2B-2E illustrate a process for generating a dating timeline 200. In one or more embodiments of the present invention, once a user profile is created on the open-source dating platform for a user on the platform, a timeline axis 200 of a dating timeline 200 is generated regardless of whether a review, rating, or the like has been submitted about the user. As such, a user which has no reviews submitted about their dating history or performance may be assigned a timeline axis 201 as depicted in FIG. 2B.

Alternatively, if a review has been submitted about the user or other person of interest, such as by an individual which does not have an account or user profile on the open-source dating platform, a timeline axis 201 of a dating timeline 200 is generated and a marker 202 is placed thereon as depicted in FIG. 2C. In the example shown, marker 202 represents a review of a person of interest's performance within a romantic relationship. In one or more embodiments, a range of dates is associated with the romantic relationship. Therefore, the placement of the markers is based on the time period that the relationship occurred. In one example, the latest relationships represented by the markers will be further to the right of the timeline axis 201. A marker 202 for a first review may be placed further to the left, center, or any suitable position on the timeline axis 201 and may be moved once, accordingly, a review for a different relationship is submitted.

FIG. 2D depicts the progression of the dating timeline 200 as a review directed to the person of interest's performance in another relationship is submitted to the open-source dating platform. Accordingly, a new marker 203 is added to the timeline axis 201 of the dating timeline 200. In the example shown, marker 203 is positioned to the right of marker 202 as the relevant relationship occurred later than that indicated by marker 202.

Next, as depicted in FIG. 2E, several other markers (e.g., marker 205) are added to the dating timeline 200 and may be displaced from each other based on the length between relationships (e.g., length 204). The markers are positions according to the start of the romantic relationships.

FIG. 3 illustrates a cluster 300 of dating timelines 301 in accordance with one embodiment consistent with the present invention. The cluster 300 of dating timelines 301 may include dating timelines 301 of persons of interest that reside in a particular region, demographic, etc. For example, cluster 300 may include dating timelines 301 assigned to heterosexual men between the ages of 30-34 which reside in the State of California. It should be understood by those having ordinary skill in the art that cluster 300 may not be limited to any number of dating timelines 301. In some implementations, cluster 300 contains a predetermined number of dating timelines 300. For instance, the open-source dating platform may cluster 10, 20, 50, or 100 dating timelines 301 in accordance with a user's preferences.

Although the open-source dating platform may provide a cluster 300 of dating timelines 301 assigned to individuals that the user may not be acquainted with, a user can also generate a cluster 300 of dating timelines 301 that are assigned to individuals that the user knows. For example, if a user is interested in several suitors, the user can request that the open-source dating platform generate a cluster 300 of dating timelines 301 associated with only these suitors. That way, the user can evaluate the dating timelines (and other digital dating artifacts) that are assigned to these suitors to determine whether any of the suitors are a good match to engage in a courtship or romantic relationship. Users can therefore leverage the open-source dating platform to make dating decisions.

In some embodiments, the clusters 300 of dating timelines 301 can be created automatically on the open-source dating platform according to pre-defined rules and without the express request from a user on the platform. For example, users that have indicated that they are seeking a romantic relationship (by their user profiles) may receive auto-generated submissions of dating profiles of other users on the platform according to pre-defined attributes and matching rules.

A dating timeline 301 can be compared to one or more pre-configured dating profiles, and then characterized. Based on the characterization of a particular dating timeline on the open-source dating platform, users can be matched and sent recommendations for courtships and romantic relationships with other users on the open-source dating platform.

A cluster 300 of dating timelines 301 can be generated on the open-source dating platform. Generating matches for users on the open-source dating platform may be based upon dating timeline similarity (commonality) or dissimilarity (based on the theory that opposites attract), etc. Accordingly, the open-source dating platform may apply various sets of rules to implement various matching strategies.

The open-source dating platform may also facilitate and even prompt users to submit a user profile. A user's profile may indicate their age, gender, sexual orientation, zodiac sign, type of romantic relationship desired, etc. As such, the open-source dating platform may generate matches for romantic relationships based on dating profile characterization and profile-based matching.

In addition, users on the open-source dating platform may create clusters 300 of dating timelines 301 out of mere interest to view dating timelines assigned to individuals in a particular demographic. Generating clusters 300 of dating timelines 301 may give a user information about the dating patterns in certain areas and for a particular demographic. For instance, if a user on the open-source dating platform plans to move to a different area of the country, and is not familiar with the dating landscape of that area, the user can use the open-source dating platform to gain a greater understanding of that area's dating norms.

The dating timelines 301 on the open-source dating platform may reveal trends such as that an above-average number of users, or dating prospects, on the platform are single (e.g., male college students). As such, third-party merchants which have access to the open-source dating platform can take advantage of data trends observed on the dating platform by running targeting advertisements to a targeted demographic of users on the platform.

In some embodiments of the present invention, property rights are afforded to the persons of interest regarding the assigned dating timelines, dating trees, sociograms, relationship images, and other digital dating artifacts. As such, the digital dating artifacts contained within the dating profile may be retrieved and used in other computing environments.

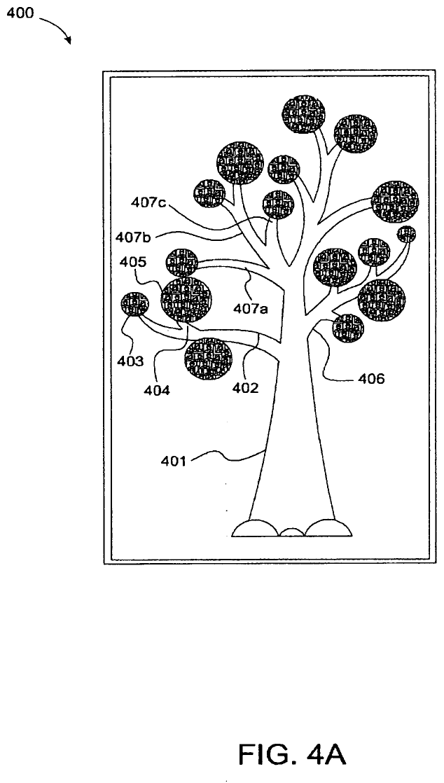

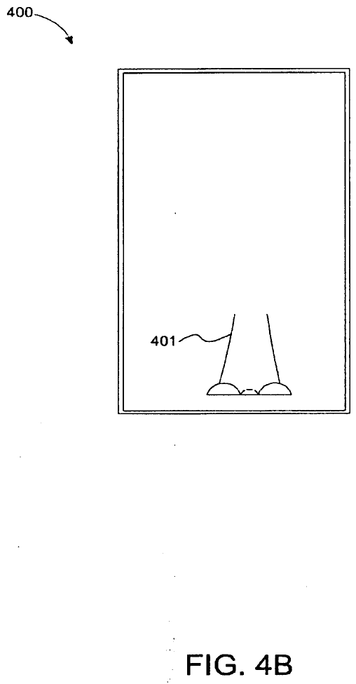

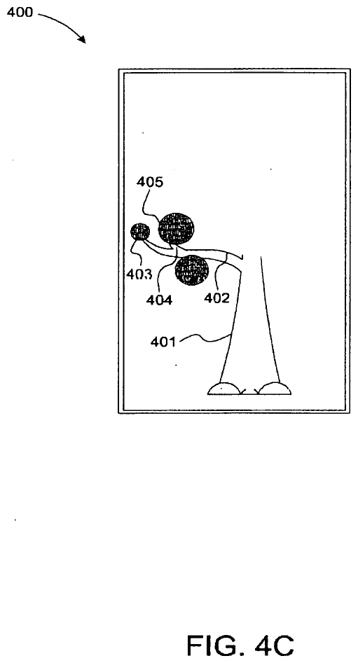

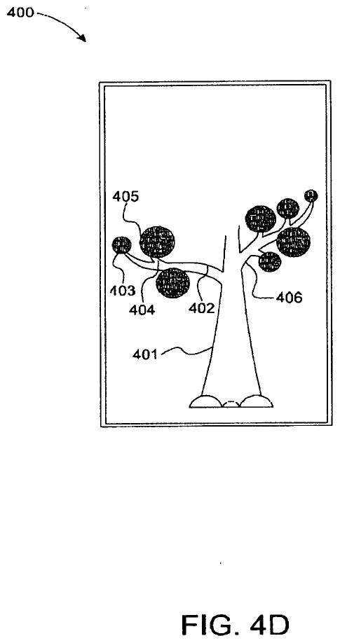

FIGS. 4A-4D illustrate an exemplary process for generating a dating tree 400 in accordance with one embodiment consistent with the present invention. As depicted, dating tree 400 includes a trunk region 401 that represents the individual (e.g., person of interest) of whom the dating tree 400 is assigned, and branch elements (e.g., branch elements 402, 406) which indicates the romantic relationships that the person of interest has been involved in.

The dating tree 400 also includes leaf elements (e.g., leaf elements 403, 405) which associated the social media network linked to each individual that the person of interest assigned the dating tree was involved with romantically. Accordingly, the dating tree 400 reflects a social network of contacts and connections linked to the individual for whom the dating tree 400 is assigned via the person of interest's past and present partner, lovers, etc. In some embodiments, contained within the social network associated with the leaf element may be highlighted, or otherwise emphasized, to show any common contacts with the user that retrieved the dating tree 400 on the open-source dating platform.

The dating tree 400 also features sub-branches. In one or more embodiments of the present invention, the sub-branches of the dating tree 400 represents a concealed relationship which began during the existence of a publicly-acknowledged monogamous relationship. Accordingly, while branch 402 represents a publicly-acknowledged monogamous relationship, sub-branch 404 represents a concealed affair which occurred during the publicly-acknowledged monogamous relationship represented by branch 402. A dating tree 400 can therefore reveal hidden connections between people which can provide for a greater understanding of human behavior, social interactions, and mating norms.

According to the previous example, while branch 402 represents a first publicly-acknowledged monogamous relationship, branch 406 can also represent a second publicly-acknowledged monogamous relationship. Furthermore, dating tree 400 also exhibits non-traditional romantic relationships. For example, dating tree 400 exhibits a polyamorous relationship by multi-branch 407 which comprises branches 407a, 407b, and 407c.

Herein, a polyamorous relationship is defined as the practice of engaging in multiple romantic, and often sexual relationships, with the consent of all the people involved. As such, there may be off-shoot, concealed relationships involved during polyamorous relationships as depicted in dating tree 400.

The dating tree 400 may be characterized such that its distinctive attributes can be correlated with other dating trees on the open-source dating platform. In addition, a dating tree 400 may be compared to pre-defined dating tree profiles to be characterized. Each of the data tree profiles may have features that are attributable to a set of traits, behaviors, and characteristics which are relevant to an individual's fitness to function properly within a romantic relationship.

Furthermore, the data associated with the dating tree 400 may be used to generate matches with other users on the open-source dating platform. For example, the social network linked to the dating tree 400 may be a factor that the open-source dating platform uses to determine available matches. For instance, anyone within the social network associated with a user's dating tree 400, which meets any qualifying attributes, may be identified as a match.

Moreover, a sociogram may be generated based on the social network included in the dating tree 400. Herein, a sociogram is defined as a graphic representation of an individual's social network. The open-source dating platform may generate a sociogram based on the social network associated with a dating tree 400 on the dating platform. The generated sociogram from the dating tree 400 may be used to recommend users on the open-source dating platform to connect. For example, users that are identified within sociogram 401 may be prompted to connect with each other just as users identified within sociogram 403 may be prompted to connect with each other. However, it should be understood by those having ordinary skill in the art that the present invention is not limited to connection recommendations of users within the same sociogram. Moreover, in some embodiments, the open-source dating platform recommends users on the dating platform which were in a romantic relationship with the same person to connect.

In some embodiments of the present invention, property rights may be afforded to the persons of interest regarding the dating timelines, dating trees, sociograms, relationship images, and other digital artifacts within one's dating profile.

FIGS. 4B-4D illustrate an exemplary process for generating a dating tree 400 in accordance with one embodiment consistent with the present invention. In one or more embodiments of the present invention, once a user profile is created on the open-source dating platform for a user on the platform, a trunk region 401 of a dating tree 400 is generated regardless of whether a review, rating, or the like has been submitted about the user. As such, a user which has no reviews submitted about their dating history or performance may be assigned a trunk region 401 as depicted in FIG. 4B.

Alternatively, if a review has been submitted about the user or other person of interest, such as an individual which does not have an account or user profile on the open-source dating platform, a trunk region 401 of a dating tree 400 is generated and a branch 402 is placed thereon as depicted in FIG. 4C. The branch 402 represents a romantic relationship that the person of interest of whom the dating tree was assigned was engaged in. A second user may post a review which may reveal a once concealed romantic relationship. For example, while branch 402 may represent a publicly-acknowledged monogamous relationship, sub-branch 404 may represent a concealed affair which occurred during the monogamous relationship represented by branch 402.

In one embodiment of the present invention, a leaf element 405 is added to the branch 402 to illustrate the social connections associated with the individual of whom the person of interest (whom the dating tree 400 was assigned) was in or is presently in.

FIG. 4D depicts the addition of branch 406. In one embodiment, new branch 406 is added in response to a submission by a new user (or non-user submitter) on the open-source dating platform. In addition, several sub-branches stem from branch 406 as depicted.

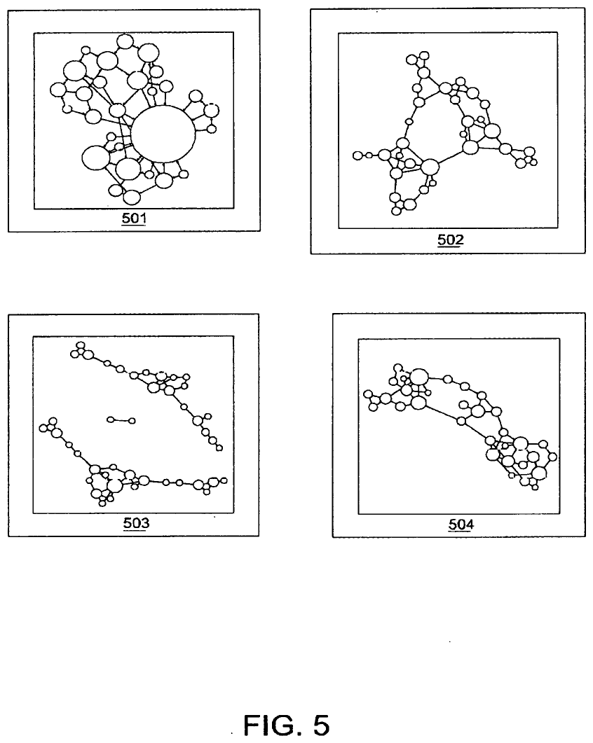

FIG. 5 are illustrations of example sociograms 501-504 in accordance with one embodiment consistent with the present invention. Sociograms 501-504 may be associated with the social network associated with users that are assigned dating trees within an open-source dating platform. Sociograms 501-504 may be accessible to third parties on a backend of the open-source dating platform via an application programming interface. Therefore, data can be sold on the backend of the open-source dating platform to third-party merchants.

It is commonly understood that two or more individuals may decide to engage in a romantic relationship. Moreover, the acquiescence by individuals to engage in romantic relationships create social constructs. Herein, a social construct is defined as an idea, concept, or perception that does not exist in objective reality but as a result of human interaction. Although romantic relationships do not exist in objective reality, as relationships are intangible, they exist because humans acknowledge their reality in daily life.

A computing system consistent with the present invention can create and assign a visual representation (e.g., visual image) of a romantic relationship. Accordingly, the present invention is not limited to an open-source dating platform that receives ratings and reviews of former partners or lovers but also of the romantic relationships. For example, a visual representation of a romantic relationship may be generated to reflect several attributes of a romantic relationship expressed in one or more reviews submitted to the open-source dating platform by participants in the relationship or by third parties. For instance, one or more users on the open-source dating platform can submit information regarding the parties involved, its duration, the user's sentiment and overall impression of the relationship, whether the relationship was public or concealed, etc. Therefore, while the open-source dating platform is configured for users to submit reviews and ratings of an individual's performance within a romantic relationship, the dating platform is also configurable to receive reviews and ratings of a romantic relationship as further described.

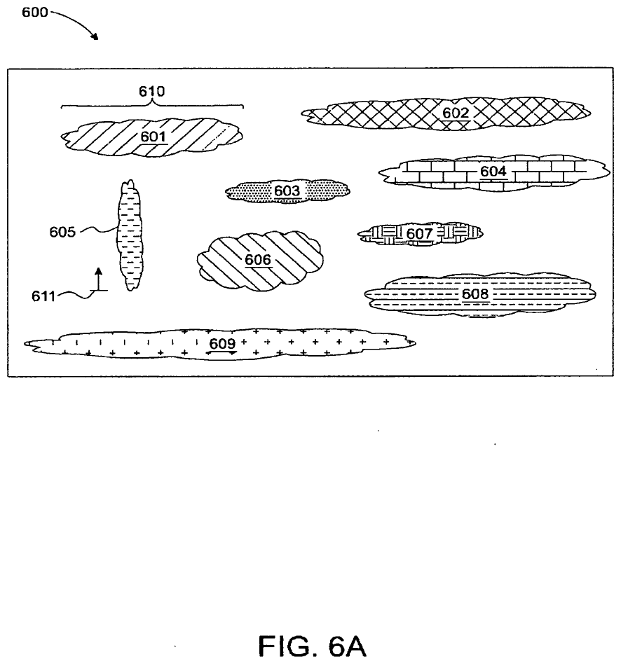

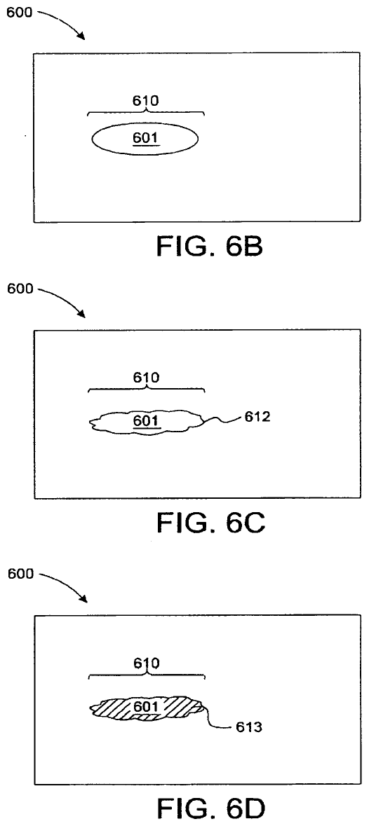

FIGS. 6A-6D illustrate an exemplary process for generating relationship images according to one or more embodiments of the present invention. The relationship images may have several attributes which express characteristics of a romantic relationship. For example, relationship image 601 has a first set of attributes such as a length 610. In some embodiments, length 610 is indicative of the time period that the romantic relationship lasted.

Relationship images 602-608 have unique visual signatures as indicated by the unique hashing. The unique hashing may indicate a specific attribute of a romantic relationship. For example, the unique hashing associated with relationship images 602-609 may indicate a lasting impression of the romantic relationships as expressed in the ratings and reviews submitted by the individuals involved or witnesses to the relationships.

Notably, relationship images 602-608 are horizontally disposed whereas relationship image 609 is vertically disposed. In some embodiments, the orientation of relationship images 602-609 indicate attributes of the romantic relationships. For example, a horizontally-disposed relationship image may be indicative of a heterosexual relationship whereas a vertically-disposed relationship image (see arrow 611) may be indicative of a same-sex relationship. Accordingly, the orientation of the relationship image as displayed may be indicative of the sexual orientation of the persons involved in the relationship.

The open-source dating platform may generate relationship images based on a set of rules. For example, the open-source dating platform may have access to a palette of characteristics relevant to a dating or romantic relationship context. The characteristics stored in the palette are associated with an attribute in two-dimensional space. For example, a monogamous heterosexual relationship may be represented as a horizontally-disposed, oval-shaped object whereas a monogamous same-sex relationship may be represented as a vertically-disposed, oval-shaped object. The time duration of the relationship may be expressed by the length or width of the object. A sentiment of the romantic relationship may be assigned a color within the palette. For example, the color blue may be associated with a romantic relationship that was filled with sorrow whereas the color red may reflect a tempestuous relationship. Hashing styles may also be included in the palette which may be assigned to one or more characteristics of a romantic relationship. For example, hashing may be assigned to a rating of the romantic relationship.

A relationship image created on the open-source dating platform can be converted to multi-dimensional bitmaps and fixed sized objects composited together by hardware. In one embodiment, a relationship image may be embodied in the form of a sprite. A relationship image can be imported to the open-source dating platform or exported therefrom. The relationship images which involve a user may be included in a user's dating profile. In some embodiments of the present invention, property rights may be afforded to the persons of interest regarding their assigned dating timelines, dating trees, sociograms, relationship images, and other digital artifacts within one's dating profile.

FIGS. 6A-6D illustrate an exemplary process for generating relationship images according to one or more embodiments of the present invention. For the purposes of these figures, an exemplary process for generating relationship image 601 is shown. In one example, the submission of a review related to a dating context causes the generation of an image on the open-source dating platform that is representative of the romantic relationship that is subject to the review. In one embodiment of the present disclosure, a monogamous relationship is assigned an oval-shaped image 601 as depicted in FIG. 6B. The length of the romantic relationship at issue may be represented as an attribute (e.g., length 610) of the oval-shaped image 601.

The open-source dating platform may add a visual effect to the image 601 to indicate the sentiment associated with the submitted review. In the example shown, the oval-shaped image 601 has an uneven, rough perimeter 612 as illustrated in FIG. 6C. In one or more embodiments of the present invention, a positive sentiment associated with a review of a romantic relationship may lead to the generation of a relatively smooth perimeter of the image 601. In contrast, a negative sentiment associated with a review of a romantic relationship may lead to the generation of a relatively uneven or rough perimeter.

Moreover, in one or more embodiments of the present invention, a hashing 613 may be applied to the oval-shaped image 601 to indicate a specific attribute of a romantic relationship. For example, hashing 613 is a visual indication associated with a rating that the person who submitted the review gave the relationship. For example, a rating of 1/10 may be associated with a specific hashing whereas a rating of 8/10 may be associated with another hashing.

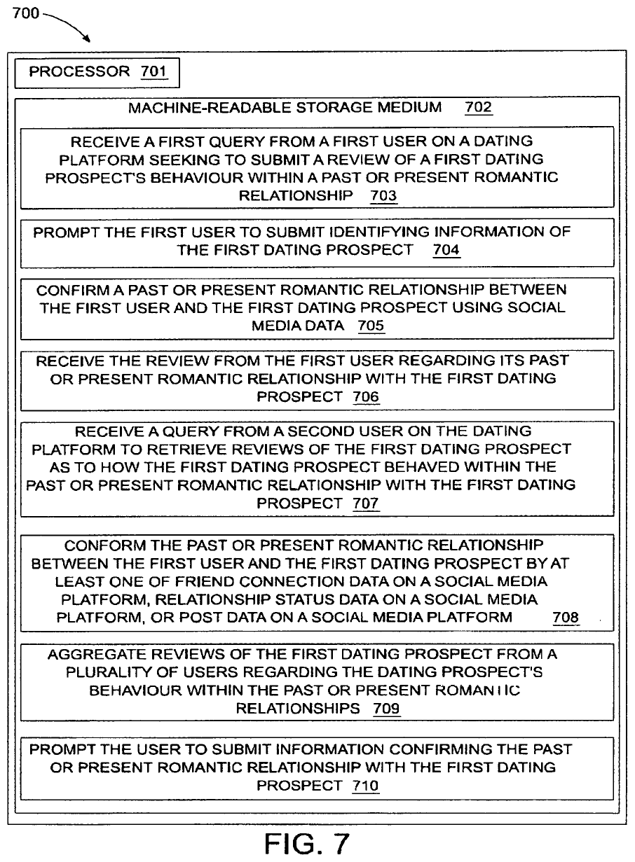

FIG. 7 is an illustration of a computing system 700 according to one or more examples of the present invention. The computing system 700 includes a non-transitory computer readable medium 702 that includes computer executable instructions 703-710 stored thereon that, when executed by one or more processing units 701 (one processor shown), causes the one or more processing units 701 to affect a dating review submission and retrieval system consistent with the present invention.

Computer readable medium 702 include computer executable instructions 703 to receive a first query from a first user on an open-source dating platform seeking to submit a review of a first dating prospect's behavior within a romantic relationship (e.g., past or present). In one or more embodiments, the open-source dating platform may feature an interface which allows users to submit or retrieve information therefrom. The review may include a rating (e.g., number of stars) according to an assessment of the romantic relationship or with respect to any attribute associated with the romantic relationship or former partner.

Computer readable medium 702 includes computer executable instructions 704 which includes instructions to prompt the first user to submit identifying information of the first dating prospect. Identifying information may comprise a full name, social media account name or handle, date of birth, picture in a digital format, etc. However, it should be understood by one having ordinary skill in the art that the present invention is not limited thereto. As such, users may submit any information, including documentation that is in digital form, to identify the dating prospect.

Computer readable medium 702 also includes computer executable instructions 705 to confirm the romantic relationship between the first user and the first dating prospect using social media data. In one example, according to computer executable instructions 708, the romantic relationship between the first user and the first dating prospect can be confirmed by at least one of friend connection data on a social media platform, relationship status data on a social media platform, or post data on a social media platform.

For example, the open-source dating platform can determine whether a relationship status was shared between the first user and the first dating prospect. In yet another example, the open-source dating platform can determine whether a connection ever existed between the first user, the dating prospects, and a threshold number of common contacts were shared on a social media platform. The length of time that the first user, dating prospect, and their shared connections may also be considered when confirming whether the romantic relationship ever occurred between the first user and the first dating prospect.

In some implementations, computer readable medium 702 includes computer executable instructions 710 to prompt the user to submit data confirming the romantic relationship with the first dating prospect.

Computer readable medium 702 also includes computer executable instructions 706 to receive the review from the first user regarding the first dating prospect's behavior within a romantic relationship.

Computer readable medium 702 further includes computer executable instructions 707 to receive a query from a second user on the open-source dating platform to retrieve a review of the first dating prospect with regards to the first dating prospect's behavior within the romantic relationship associated with the first dating prospect.

Computer readable medium 702 includes computer executable instructions 709 to aggregate reviews of the first dating prospect from a plurality of users regarding the first dating prospect's behavior within the romantic relationship. Therefore, when a second user seeks to retrieve reviews associated with the first dating prospect, the second user can access each review submitted to the open-source dating platform associated with the dating prospect.

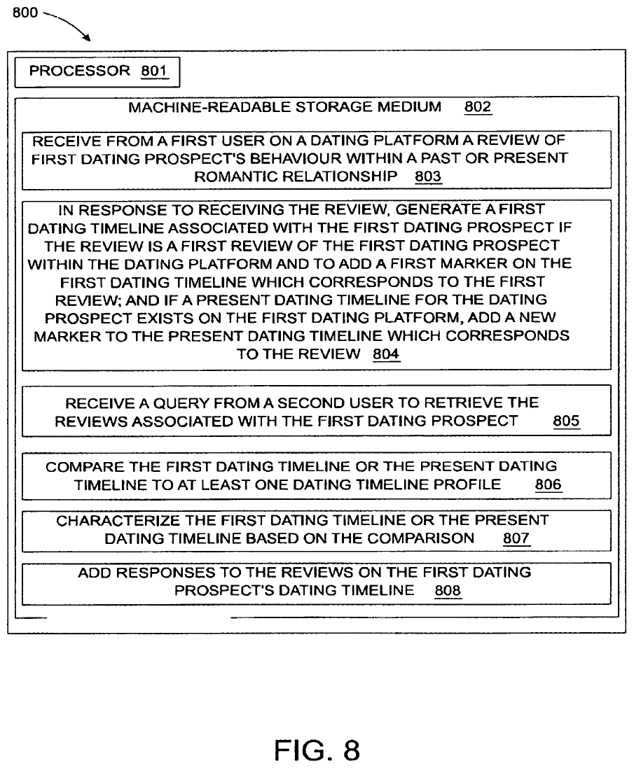

FIG. 8 is an illustration of a computing system 800 according to one or more examples of the present invention. The computing system 800 includes a non-transitory computer readable medium 802 that includes computer executable instructions 803-808 stored thereon that, when executed by one or more processing units 801 (one processor shown), causes the one or more processing units 801 to generate dating timelines.

Computer readable medium 802 includes computer executable instructions 803 to receive from a first user on an open-source dating platform a review of a first dating prospect's behavior within a romantic relationship. The review may include an assessment of the first dating prospect's persona, sexual performance, career accomplishments, career goals, lifestyle, persona, financial responsibility, communication skills, etc.

In addition, computer readable medium 802 includes computer executable instructions 804 to generate a first dating timeline based on their review if the review is a first review of the first dating prospect, and to add a first marker on the first dating timeline which corresponds to the first review in response to receiving the review. If a present dating timeline for the first dating prospect exists on the open-source dating platform, computer executable instructions 802 are to add a new marker to the present dating timeline which corresponds to the review. The dating timeline generated may exhibit the dating timeline 200 exhibited in FIG. 2.

The markers on the dating timelines may include several attributes such as a first attribute that is indicative of a romantic relationship type, a second attribute that is indicative of the reviewer's sentiment of the romantic relationship shared with the first dating prospect, or a third attribute that is indicative of a number of users which have confirmed that a romantic relationship existed between the first user and the first dating prospect.

Computer readable medium 802 includes computer executable instructions 805 to receive a query from a second user to retrieve the reviews of the first dating prospect's behavior within the romantic relationship.

Computer readable medium 802 includes computer executable instructions 806 to compare the first dating timeline or the present dating timeline to at least one dating timeline profile. In one or more embodiments of the present invention, the at least one dating timeline profile is a dating profile associated with a particular demographic. For example, the dating timeline profile may be reflective of single, heterosexual men between the ages of 30-35 that reside in the Southeastern region of the United States.

Computer readable medium 802 also includes computer executable instructions 807 to characterize the first dating timeline or the present dating timeline based on the comparison. In one or more implementations, the dating timeline associated with the dating prospect is characterized by the best match of its dating timeline to the dating timeline profiles. A description of each dating timeline profile may be revealed to users on the open-source dating platform.

Computer readable medium 802 includes computer executable instructions 808 to add responses to the reviews on the first dating prospect's dating timeline. Users on the platform can therefore add responses to each review that is listed on the dating prospect's dating timeline. In one embodiment, the individual to whom the dating timeline is assigned is allowed to submit responses to markers on the dating timeline upon confirmation that the submitter and the individual that is subject to review are at least within the same social network.

In addition, computer readable medium 802 includes computer executable instructions to receive from a third user on the open-source dating platform a confirmation as a witness that the romantic relationship existed between the first user and the first dating prospect.

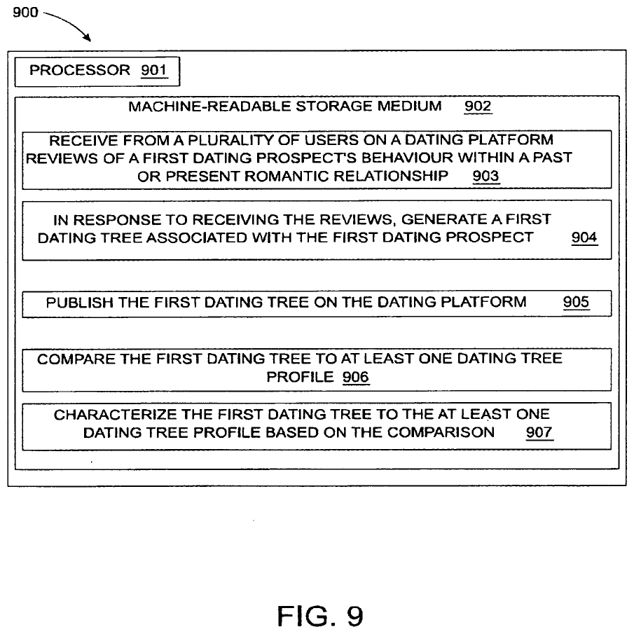

FIG. 9 is an illustration of a computing system according to one or more examples of the present invention. The computing system 900 includes a non-transitory computer readable medium 902 that includes computer executable instructions 903-907 stored thereon that, when executed by one or more processing units 901 (one processor shown), causes the one or more processing units 901 to generate dating trees.

Computer readable medium 902 includes computer executable instructions 904 to receive from a plurality of users on an open-source dating platform ratings and reviews, including names of individuals which shared past or present romantic relationship with the person of interest (e.g., first dating prospect) to whom the dating tree is assigned. In response to receiving the reviews, computer readable medium 902 includes computer executable instructions to generate a first dating tree associated with the first dating prospect.

Computer readable medium 902 includes computer executable instructions 905 to publish the first dating tree on the open-source dating platform. For example, the first dating tree may be displayed such that users can view them on the dating platform. Additionally, computer readable medium 902 includes computer executable instructions 906 to compare the first dating tree to at least one dating tree profile. Lastly, computer readable medium 902 includes computer executable instructions 907 to characterize the first dating tree based on the comparison.

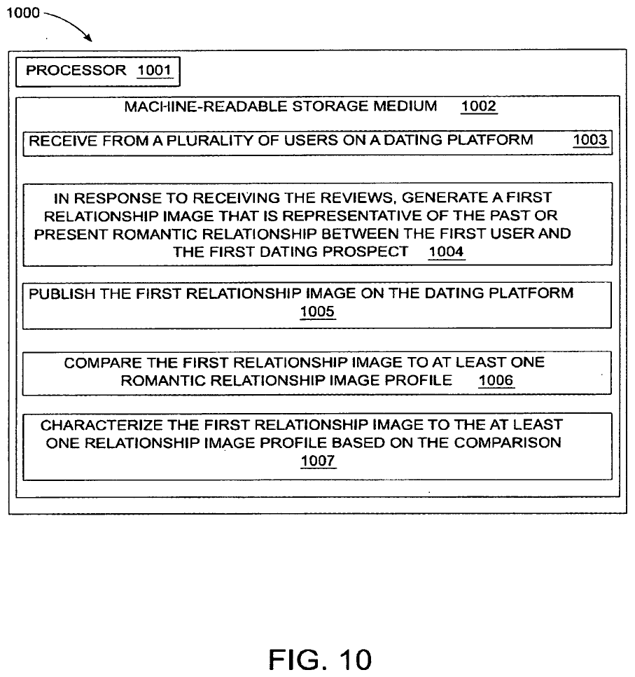

FIG. 10 is an illustration of a computing system according to one or more examples of the present invention. The computing system 1000 includes a non-transitory computer readable medium 1002 that includes computer executable instructions 1003-1007 stored thereon that, when executed by one or more processing units 1001 (one processor shown), causes the one or more processing units 1001 to generate relationship images based on submitted ratings and reviews.

Computer readable medium 1002 includes computer executable instructions 1003 to receive from a first user on an open-source dating platform reviews of a romantic relationship with a person of interest (e.g., first dating prospect). Next, computer readable medium 1002 includes computer executable instructions 1004 to generate a first relationship image that is representative of the romantic relationship between the first user and the first dating prospect in response to receiving the review.

Computer readable medium 1002 further includes computer executable instructions 1005 to publish the first relationship image on the open-source dating platform. Computer readable medium 1002 includes computer executable instructions 1006 to characterize the first relationship image based on a comparison. Computer readable medium 1002 further includes computer executable instructions 1007 to prompt a plurality of users on the open-source dating platform, which share a similar romantic relationship image, to join a group (e.g., support group) within the open-source dating platform.

The open-source dating platform can therefore improve the dating landscape by exposing bad actors. The open-source dating platform provides individuals which seek serious, long-term relationships a resource to gain a better understanding of the true intentions of their dating prospects. The open-source dating platform can facilitate the download of digital dating artifacts contained in a person of interest's dating profile. Furthermore, the open-source dating platform can facilitate the upload of digital dating artifacts created on different platforms as they pertain to an individual's dating performance and dating history.

The open-source dating platform can generate a digital dating log with all of a user's digital dating artifacts. In one embodiment, the digital dating log is a listing of digital dating artifacts and a downloadable representation of a dating profile. The digital dating log can be uploaded to different platforms. Accordingly, individuals that are in the dating market may require that potential suitors or dating prospects submit their digital dating logs for their review prior to a date, courtship, or romantic relationship. The open-source dating platform may implement a set of rules to evaluate a person of interest based on its characterization of the digital dating artifacts contained in a dating profile.

The digital dating log may be downloaded to one's digital wallet or added to one's social media profile. In addition, the digital dating artifacts and/or digital dating logs may be added to a public digital ledger, such as on the Blockchain, to maintain the integrity of the digital dating logs.

While illustrative implementations of the application have been described in detail herein, it is to be understood that the inventive concepts may be otherwise variously embodied and employed, and that the appended claims are intended to be construed to include such variations, except as limited by the prior art.

Reference throughout this specification to “one implementation” or “an implementation” means that a particular feature, structure, or characteristic described in connection with the implementation is included in at least one implementation of the present invention. Thus, the appearances of the phrases “in one implementation” or “in some implementations” in various places throughout this specification are not necessarily all referring to the same implementation. Furthermore, the particular features, structures, or characteristics may be combined in any suitable manner in one or more implementations.

Systems and methods describing the present invention have been described. It will be understood that the descriptions of some embodiments of the present invention do not limit the various alternative, modified, and equivalent embodiments which may be included within the spirit and scope of the present invention as defined by the appended claims. Furthermore, in the detailed description above, numerous specific details are set forth to provide an understanding of various embodiments of the present invention. However, some embodiments of the present invention may be practiced without these specific details. In other instances, well known methods, procedures, and components have not been described in detail so as not to unnecessarily obscure aspects of the present embodiments.

1. A computing device comprising a non-transitory machine-readable storage medium containing instructions that, when executed, causes a machine to:
receive a first query from a first user on an open-source dating platform seeking to submit a review of a first dating prospect's behavior within a romantic relationship;
prompt the first user to submit identifying information of the first dating prospect;
confirm the romantic relationship between the first user and the first dating prospect using social media data; and
receive the review from the first user regarding its romantic relationship with the first dating prospect.

2. The computing device comprising a non-transitory machine-readable storage medium of claim 1, further containing instructions, that when executed, causes the machine to receive a query from a second user on the open-source dating platform to retrieve reviews of the romantic relationship associated with the first dating prospect.

3. The computing device comprising a non-transitory machine-readable storage medium of claim 1, further containing instructions, that when executed, causes the machine to confirm the romantic relationship between the first user and the first dating prospect by at least one of friend connection data on a social media platform, relationship status data on a social media platform, or post data from a social medial platform.

4. The computing device comprising a non-transitory machine-readable storage medium of claim 1, further containing instructions, that when executed, causes the machine to aggregate reviews regarding romantic relationships with the first dating prospect from a plurality of users.

5. The computing device comprising a non-transitory machine-readable storage medium of claim 1, further containing instructions, that when executed, causes the machine to prompt the user to submit information confirming the romantic relationship with the first dating prospect.

6. A computing device comprising a non-transitory machine-readable storage medium containing instructions that, when executed, causes a machine to:
receive from a first user on a dating platform a review of a romantic relationship with a first dating prospect; and
in response to receiving the review,
create a first dating timeline associated with the first dating prospect if the review is a first review of the romantic relationship with the dating prospect within the dating platform and to add a first marker on the first dating timeline which corresponds to the first review; and
if a present dating timeline for the dating prospect exists on the dating platform, add a new marker to the present dating timeline which corresponds to the review,
wherein each marker includes a first attribute that is indicative of a romantic relationship type, a second attribute that is indicative of the reviewer's sentiment of the romantic relationship with the first dating prospect, or a third attribute that is indicative of a number of users which have confirmed that a romantic relationship existed between the first user and the first dating prospect.

7. The computing device comprising a non-transitory machine-readable storage medium of claim 6, further containing instructions, that when executed, causes a machine to receive a query from a second user to retrieve the reviews associated with the romantic relationship with the first dating prospect.

8. The computing device comprising a non-transitory machine-readable storage medium of claim 6, further containing instructions, that when executed, causes a machine to compare the first dating timeline or the present dating timeline to at least one dating timeline profile.

9. The computing device comprising a non-transitory machine-readable storage medium of claim 8, wherein the at least one dating timeline profile is a dating profile associated with a particular demographic.

10. The computing device comprising a non-transitory machine-readable storage medium of claim 9, further containing instructions, that when executed, causes a machine to characterize the first dating timeline or present dating timeline based on the comparison.

11. The computing device comprising a non-transitory machine-readable storage medium of claim 10, wherein the characterization includes an assessment as to an ability of the first dating prospect to function within a romantic relationship.

12. The computing device comprising a non-transitory machine-readable storage medium of claim 11, wherein the assessment includes a score regarding the first dating prospect's fitness to function within a romantic relationship.

13. The computing device comprising a non-transitory machine-readable storage medium of claim 6, further containing instructions, that when executed, causes a machine to add responses to the reviews on the first dating prospect's dating timeline.

14. A computing device comprising non-transitory machine-readable storage medium containing instructions that, when executed, causes a machine to:
receive reviews on a dating platform from a plurality of users regarding a romantic relationship with a first dating prospect, and
in response to receiving the reviews,
create a first dating tree associated with the first dating prospect based on the reviews; and
if a present dating tree for the first dating prospect exists on the dating platform, add a new branch element to the present dating tree which corresponds with the submitted review,
wherein the first dating tree or the present dating tree includes a branch element for each user which indicates a romantic relationship with the first dating prospect,
wherein the present dating tree further includes a leaf element which includes social media connections linked to each user that submitted a review of their romantic relationship with the first dating prospect such that the first dating tree reflects a social network of connections linked to the first dating prospect.

15. The computing device comprising a non-transitory machine-readable storage medium of claim 14, further containing instructions, that when executed, causes a machine to prompt each user to connect with each of the plurality of users that indicated a romantic relationship with the first dating prospect.

16. The computing device comprising a non-transitory machine-readable storage medium of claim 14, further containing instructions, that when executed, causes a machine to publish the first dating tree or the present dating tree on the dating platform.

17. The computing device comprising a non-transitory machine-readable storage medium of claim 14, further containing instructions, that when executed, causes a machine to compare the first dating tree or the present dating tree to at least one dating tree profile.

18. The computing device comprising a non-transitory machine-readable storage medium of claim 17, further containing instructions, that when executed, causes a machine to characterize the first dating tree or the present dating tree to the at least one dating tree profile based on the comparison.

19. The computing device comprising a non-transitory machine-readable storage medium of claim 14, further containing instructions, that when executed, causes a machine to generate a sociogram that includes the social network of connections linked to the first dating tree.

20. The computing device comprising a non-transitory machine-readable storage medium of claim 15, further containing instructions, that when executed, causes a machine to generate a two-dimensional digital object rendering of the first dating tree which is downloadable from the open-source dating platform.
